(19) United States
(12) Patent Application Publication
(10) Pub. No.: US 2025/0264599 A1
(43) Pub. Date: Aug. 21, 2025

(54) SYNCHRONIZING CAMERA, LIDAR AND RADAR FOR OBJECT DETECTION USING RADAR-GUIDED SCENE FLOW ESTIMATION AND ADAPTIVE ATTENTION

(71) Applicant: QUALCOMM Incorporated, San Diego, CA (US)

(72) Inventors: Venkatraman Narayanan, Farmington Hills, MI (US); Varun Ravi Kumar, San Diego, CA (US); Senthil Kumar Yogamani, Headford (IE)

(21) Appl. No.: 18/583,473

(22) Filed: Feb. 21, 2024

(51) Int. Cl. G01S 13/72; G01S 7/41; G01S 13/86; G01S 13/931; G06T 7/246

(52) U.S. Cl. CPC G01S 13/726; G01S 7/415; G01S 13/865; G01S 13/867; G01S 13/931; G06T 7/246; G06T 2207/10028; G06T 2207/30261

(57) ABSTRACT

This disclosure provides systems, methods, and devices for vehicle driving assistance systems that support enhanced sensor fusion techniques. In a first aspect, a method of includes receiving point cloud data for two or more frames from a radar device and generating scene flow parameter data based on the point cloud data. The method also includes generating voxel position adjustment data based on the scene flow parameter data, and generating feature concatenation information associated with two or more sensors based on the voxel position adjustment data and feature information associated with the two or more sensors. The method further includes performing feature detection and tracking based on the feature concatenation information to generate tracking information for one or more objects, and outputting the tracking information. Other aspects and features are also claimed and described.

### TECHNICAL FIELD

Aspects of the present disclosure relate generally to driver-operated or driver-assisted vehicles, and more particularly, to methods and systems suitable for supplying driving assistance or for autonomous driving.

### INTRODUCTION

Vehicles take many shapes and sizes, are propelled by a variety of propulsion techniques, and carry cargo including humans, animals, or objects. These machines have enabled the movement of cargo across long distances, movement of cargo at high speed, and movement of cargo that is larger than could be moved by human exertion. Vehicles originally were driven by humans to control speed and direction of the cargo to arrive at a destination. Human operation of vehicles has led to many unfortunate incidents resulting from the collision of vehicle with vehicle, vehicle with object, vehicle with human, or vehicle with animal. As research into vehicle automation has progressed, a variety of driving assistance systems have been produced and introduced. These include navigation directions by GPS, adaptive cruise control, lane change assistance, collision avoidance systems, night vision, parking assistance, and blind spot detection.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Human operators of vehicles can be distracted, which is one factor in many vehicle crashes. Driver distractions can include changing the radio, observing an event outside the vehicle, and using an electronic device, etc. Sometimes circumstances create situations that even attentive drivers are unable to identify in time to prevent vehicular collisions. Aspects of this disclosure, provide improved systems for assisting drivers in vehicles with enhanced situational awareness when driving on a road.

Example implementations provide enhanced systems and methods for synchronizing sensor data from different types of sensors for object detection and tracking. Synchronizing sensor data from different sensors is often referred to as sensor fusion. Sensor fusion can improve object detection and tracking operations by leveraging the strengths of different sensors to improve the object detection and tracking results and offset the weaknesses or limitations of other sensors. In some implementations, radar scene flow estimation can be used to fuse sensor data from other types of sensors, and optionally from the radar itself. Radar sensors may provide more accurate estimations of object motion, and the object motion determined from radar sensors can be used to help correct other sensor data and/or be used to fuse sensor data for robust object detection and tracking.

In some implementations, the enhanced sensor fusion systems and techniques described herein can improve object detection and tracking results, especially object tracking over time and object detection and tracking in challenging operating conditions or scenarios, such as low-light conditions and visually occluded situations.

In one aspect of the disclosure, a method includes: receiving point cloud data for two or more frames from a radar device; generating scene flow parameter data based on the point cloud data; generating voxel position adjustment data based on the scene flow parameter data; generating feature concatenation information associated with two or more sensors based on the voxel position adjustment data and feature information associated with the two or more sensors; performing feature detection and tracking based on the feature concatenation information to generate tracking information for one or more objects; and outputting the tracking information.

In an additional aspect of the disclosure, a device includes a processing system that includes processor circuitry and memory circuitry that stores code and is coupled with the processor circuitry, the processing system configured to cause the device to: receive point cloud data for two or more frames from a radar device; generate scene flow parameter data based on the point cloud data; generate voxel position adjustment data based on the scene flow parameter data; generate feature concatenation information associated with two or more sensors based on the voxel position adjustment data and feature information associated with the two or more sensors; perform feature detection and tracking based on the feature concatenation information to generate tracking information for one or more objects; and output the tracking information.

In an additional aspect of the disclosure, a non-transitory computer-readable medium stores instructions that, when executed by a processor, cause the processor to perform operations. The operations include: receiving point cloud data for two or more frames from a radar device; generating scene flow parameter data based on the point cloud data;

generating voxel position adjustment data based on the scene flow parameter data; generating feature concatenation information associated with two or more sensors based on the voxel position adjustment data and feature information associated with the two or more sensors; performing feature detection and tracking based on the feature concatenation information to generate tracking information for one or more objects; and outputting the tracking information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) ng networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). 5G networks include diverse deployments, diverse spectrum, and diverse services and devices that may be implemented using an OFDM-based unified, air interface.

The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mm Wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mm Wave components at a TDD of 28 GHz, subcarrier spacing may occur with 120 kHz over a 500 MHz bandwidth.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur.

Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a perspective view of a motor vehicle with a driver monitoring system according to embodiments of this disclosure.

FIG. 2 shows a block diagram of an example image processing configuration for a vehicle according to one or more aspects of the disclosure.

FIG. 3 is a block diagram illustrating details of an example wireless communication system according to one or more aspects.

FIG. 4 is a block diagram illustrating enhanced sensor fusion operations according to one or more aspects of the disclosure.

FIG. 5 is a flow chart illustrating an example method for enhanced sensor fusion operations according to one or more aspects of the disclosure.

FIG. 6 is a flow chart illustrating an example method for feature information generation operations with spatio-temporal conditional attention for enhanced sensor fusion according to one or more aspects of the disclosure.

FIG. 7 is a flow chart illustrating an example method for Radar-Oriented Flow Estimation (ROFE) operations for enhanced sensor fusion according to one or more aspects of the disclosure.

FIG. 8 is a flow chart illustrating an example method for Static Flow Refinement (SFR) module operations for enhanced sensor fusion according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

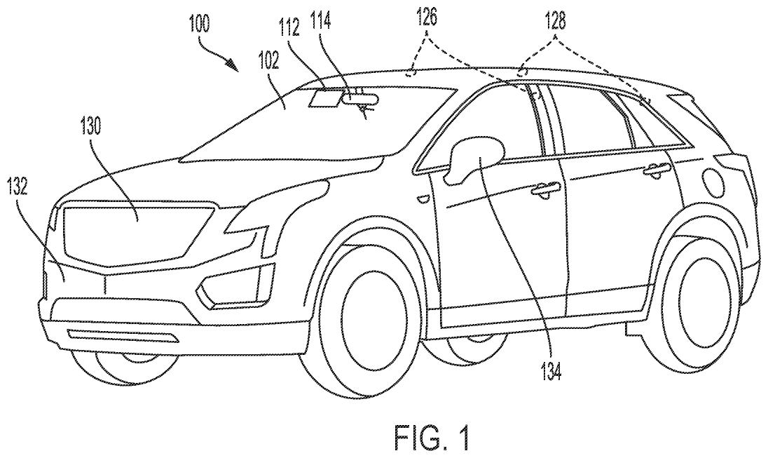

FIG. 1 is a perspective view of a motor vehicle with a driver monitoring system according to embodiments of this disclosure. A vehicle 100 may include a front-facing camera 112 mounted inside the cabin looking through the windshield 102. The vehicle may also include a cabin-facing camera 114 mounted inside the cabin looking towards occupants of the vehicle 100, and in particular the driver of the vehicle 100. Although one set of mounting positions for cameras 112 and 114 are shown for vehicle 100, other mounting locations may be used for the cameras 112 and 114. For example, one or more cameras may be mounted on one of the driver or passenger B pillars 126 or one of the driver or passenger C pillars 128, such as near the top of the pillars 126 or 128. As another example, one or more cameras may be mounted at the front of vehicle 100, such as behind the radiator grill 130 or integrated with bumper 132. As a further example, one or more cameras may be mounted as part of a driver or passenger side mirror assembly 134.

The camera 112 may be oriented such that the field of view of camera 112 captures a scene in front of the vehicle 100 in the direction that the vehicle 100 is moving when in drive mode or forward direction. In some embodiments, an additional camera may be located at the rear of the vehicle 100 and oriented such that the field of view of the additional camera captures a scene behind the vehicle 100 in the direction that the vehicle 100 is moving when in reverse direction. Although embodiments of the disclosure may be described with reference to a “front-facing” camera, referring to camera 112, aspects of the disclosure may be applied similarly to a “rear-facing” camera facing in the reverse direction of the vehicle 100. Thus, the benefits obtained while the operator is driving the vehicle 100 in a forward direction may likewise be obtained while the operator is driving the vehicle 100 in a reverse direction.

Further, although embodiments of the disclosure may be described with reference a “front-facing” camera, referring to camera 112, aspects of the disclosure may be applied similarly to an input received from an array of cameras mounted around the vehicle 100 to provide a larger field of view, which may be as large as 360 degrees around parallel to the ground and/or as large as 360 degrees around a vertical direction perpendicular to the ground. For example, additional cameras may be mounted around the outside of vehicle 100, such as on or integrated in the doors, on or integrated in the wheels, on or integrated in the bumpers, on or integrated in the hood, and/or on or integrated in the roof.

The camera 114 may be oriented such that the field of view of camera 114 captures a scene in the cabin of the vehicle and includes the user operator of the vehicle, and in particular the face of the user operator of the vehicle with sufficient detail to discern a gaze direction of the user operator.

Each of the cameras 112 and 114 may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a telephoto image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur in a camera module with a lens cluster, in which the multiple image sensors and associated lenses are located in offset locations within the camera module. Additional image sensors may be included with larger, smaller, or same fields of view.

Each image sensor may include means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), and/or time of flight detectors. The apparatus may further include one or more means for accumulating and/or focusing light rays into the one or more image sensors (including simple lenses, compound lenses, spherical lenses, and non-spherical lenses). These components may be controlled to capture the first, second, and/or more image frames. The image frames may be processed to form a single output image frame, such as through a fusion operation, and that output image frame further processed according to the aspects described herein.

As used herein, image sensor may refer to the image sensor itself and any certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end or other circuitry for converting analog signals to digital representations for the image frame that are provided to digital circuitry coupled to the image sensor.

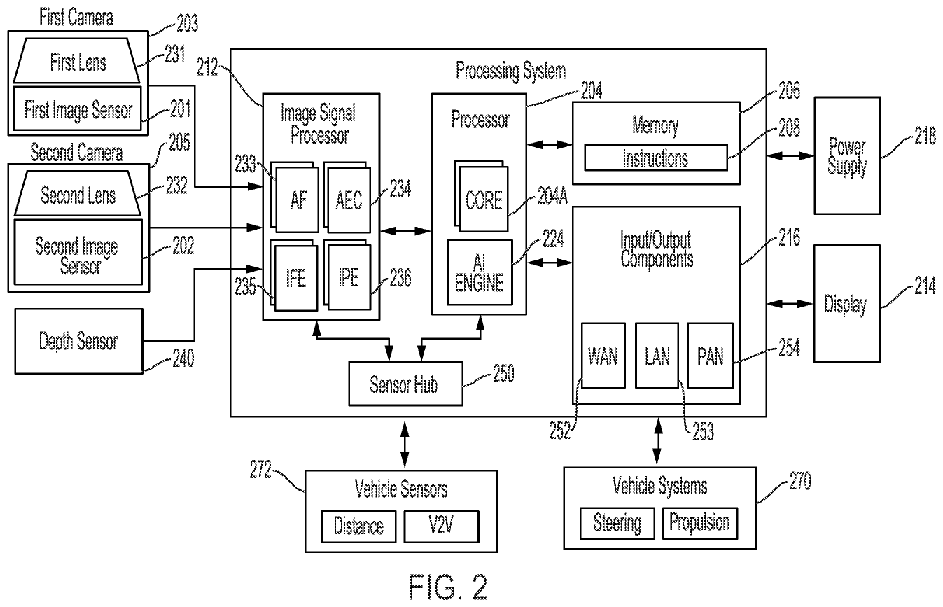

FIG. 2 shows a block diagram of an example image processing configuration for a vehicle according to one or more aspects of the disclosure. The vehicle 100 may include, or otherwise be coupled to, an image signal processor 212 for processing image frames from one or more image sensors, such as a first image sensor 201, a second image sensor 202, and a depth sensor 240. In some implementations, the vehicle 100 also includes or is coupled to a processor (e.g., CPU) 204 and a memory 206 storing instructions 208. The vehicle 100 may also include or be coupled to a display 214 and input/output (I/O) components 216. I/O components 216 may be used for interacting with a user, such as a touch screen interface and/or physical buttons. I/O components 216 may also include network interfaces for communicating with other devices, such as other vehicles, an operator's mobile devices, and/or a remote monitoring system. The network interfaces may include one or more of a wide area network (WAN) adaptor 252, a local area network (LAN) adaptor 253, and/or a personal area network (PAN) adaptor 254. An example WAN adaptor 252 is a 4G LTE or a 5G NR wireless network adaptor. An example LAN adaptor 253 is an IEEE 802.11 WiFi wireless network adapter. An example PAN adaptor 254 is a Bluetooth wireless network adaptor. Each of the adaptors 252, 253, and/or 254 may be coupled to an antenna, including multiple antennas configured for primary and diversity reception and/or configured for receiving specific frequency bands. The vehicle 100 may further include or be coupled to a power supply 218, such as a battery or an alternator. The vehicle 100 may also include or be coupled to additional features or components that are not shown in FIG. 2. In one example, a wireless interface, which may include one or more transceivers and associated baseband processors, may be coupled to or included in WAN adaptor 252 for a wireless communication device. In a further example, an analog front end (AFE) to convert analog image frame data to digital image frame data may be coupled between the image sensors 201 and 202 and the image signal processor 212.

The vehicle 100 may include a sensor hub 250 for interfacing with sensors to receive data regarding movement of the vehicle 100, data regarding an environment around the vehicle 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. In further examples, a non-camera sensor may be a global positioning system (GPS) receiver, a light detection and ranging (LiDAR) system, a radio detection and ranging (RADAR) system, or other ranging systems. For example, the sensor hub 250 may interface to a vehicle bus for sending configuration commands and/or receiving information from vehicle sensors 272, such as distance (e.g., ranging) sensors or vehicle-to-vehicle (V2V) sensors (e.g., sensors for receiving information from nearby vehicles).

The image signal processor (ISP) 212 may receive image data, such as used to form image frames. In one embodiment, a local bus connection couples the image signal processor 212 to image sensors 201 and 202 of a first camera 203, which may correspond to camera 112 of FIG. 1, and second camera 205, which may correspond to camera 114 of FIG. 1, respectively. In another embodiment, a wire interface may couple the image signal processor 212 to an external image sensor. In a further embodiment, a wireless interface may couple the image signal processor 212 to the image sensor 201, 202.

The first camera 203 may include the first image sensor 201 and a corresponding first lens 231. The second camera 205 may include the second image sensor 202 and a corresponding second lens 232. Each of the lenses 231 and 232 may be controlled by an associated autofocus (AF) algorithm 233 executing in the ISP 212, which adjust the lenses 231 and 232 to focus on a particular focal plane at a certain scene depth from the image sensors 201 and 202. The AF algorithm 233 may be assisted by depth sensor 240. In some embodiments, the lenses 231 and 232 may have a fixed focus.

The first image sensor 201 and the second image sensor 202 are configured to capture one or more image frames. Lenses 231 and 232 focus light at the image sensors 201 and 202, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging.

In some embodiments, the image signal processor 212 may execute instructions from a memory, such as instructions 208 from the memory 206, instructions stored in a separate memory coupled to or included in the image signal processor 212, or instructions provided by the processor 204. In addition, or in the alternative, the image signal processor 212 may include specific hardware (such as one or more integrated circuits (ICs)) configured to perform one or more operations described in the present disclosure. For example, the image signal processor 212 may include one or more image front ends (IFEs) 235, one or more image post-processing engines (IPEs) 236, and or one or more auto exposure compensation (AEC) 234 engines. The AF 233, AEC 234, IFE 235, IPE 236 may each include application-specific circuitry, be embodied as software code executed by the ISP 212, and/or a combination of hardware within and software code executing on the ISP 212.

In some implementations, the memory 206 may include a non-transient or non-transitory computer readable medium storing computer-executable instructions 208 to perform all or a portion of one or more operations described in this disclosure. In some implementations, the instructions 208 include a camera application (or other suitable application) to be executed during operation of the vehicle 100 for generating images or videos. The instructions 208 may also include other applications or programs executed for the vehicle 100, such as an operating system, mapping applications, or entertainment applications. Execution of the camera application, such as by the processor 204, may cause the vehicle 100 to generate images using the image sensors 201 and 202 and the image signal processor 212. The memory 206 may also be accessed by the image signal processor 212 to store processed frames or may be accessed by the processor 204 to obtain the processed frames. In some embodiments, the vehicle 100 includes a system on chip (SoC) that incorporates the image signal processor 212, the processor 204, the sensor hub 250, the memory 206, and input/output components 216 into a single package.

In some embodiments, at least one of the image signal processor 212 or the processor 204 executes instructions to perform various operations described herein, including object detection, risk map generation, driver monitoring, and driver alert operations. For example, execution of the instructions can instruct the image signal processor 212 to begin or end capturing an image frame or a sequence of image frames. In some embodiments, the processor 204 may include one or more general-purpose processor cores 204A capable of executing scripts or instructions of one or more software programs, such as instructions 208 stored within the memory 206. For example, the processor 204 may include one or more application processors configured to execute the camera application (or other suitable application for generating images or video) stored in the memory 206.

In executing the camera application, the processor 204 may be configured to instruct the image signal processor 212 to perform one or more operations with reference to the image sensors 201 or 202. For example, the camera application may receive a command to begin a video preview display upon which a video comprising a sequence of image frames is captured and processed from one or more image sensors 201 or 202 and displayed on an informational display on display 214 in the cabin of the vehicle 100.

In some embodiments, the processor 204 may include ICs or other hardware (e.g., an artificial intelligence (AI) engine 224) in addition to the ability to execute software to cause the vehicle 100 to perform a number of functions or operations, such as the operations described herein. In some other embodiments, the vehicle 100 does not include the processor 204, such as when all of the described functionality is configured in the image signal processor 212.

In some embodiments, the display 214 may include one or more suitable displays or screens allowing for user interaction and/or to present items to the user, such as a preview of the image frames being captured by the image sensors 201 and 202. In some embodiments, the display 214 is a touch-sensitive display. The I/O components 216 may be or include any suitable mechanism, interface, or device to receive input (such as commands) from the user and to provide output to the user through the display 214. For example, the I/O components 216 may include (but are not limited to) a graphical user interface (GUI), a keyboard, a mouse, a microphone, speakers, a squeezable bezel, one or more buttons (such as a power button), a slider, a switch, and so on. In some embodiments involving autonomous driving, the I/O components 216 may include an interface to a vehicle's bus for providing commands and information to and receiving information from vehicle systems 270 including propulsion (e.g., commands to increase or decrease speed or apply brakes) and steering systems (e.g., commands to turn wheels, change a route, or change a final destination).

While shown to be coupled to each other via the processor 204, components (such as the processor 204, the memory 206, the image signal processor 212, the display 214, and the I/O components 216) may be coupled to each another in other various arrangements, such as via one or more local buses, which are not shown for simplicity. While the image signal processor 212 is illustrated as separate from the processor 204, the image signal processor 212 may be a core of a processor 204 that is an application processor unit (APU), included in a system on chip (SoC), or otherwise included with the processor 204. While the vehicle 100 is referred to in the examples herein for including aspects of the present disclosure, some device components may not be shown in FIG. 2 to prevent obscuring aspects of the present disclosure. Additionally, other components, numbers of components, or combinations of components may be included in a suitable vehicle for performing aspects of the present disclosure. As such, the present disclosure is not limited to a specific device or configuration of components, including the vehicle 100.

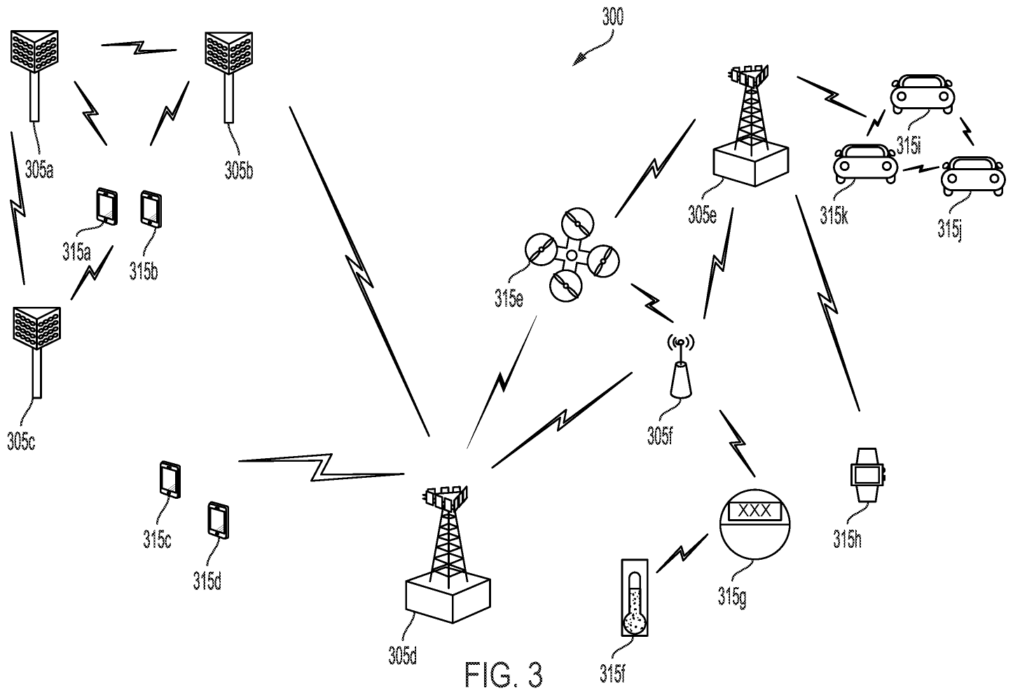

The vehicle 100 may communicate as a user equipment (UE) within a wireless network 300, such as through WAN adaptor 252, as shown in FIG. 3. FIG. 3 is a block diagram illustrating details of an example wireless communication system according to one or more aspects. Wireless network 300 may, for example, include a 5G wireless network. As appreciated by those skilled in the art, components appearing in FIG. 3 are likely to have related counterparts in other network arrangements including, for example, cellular-style network arrangements and non-cellular-style-network arrangements (e.g., device-to-device or peer-to-peer or ad-hoc network arrangements, etc.).

Wireless network 300 illustrated in FIG. 3 includes base stations 305 and other network entities. A base station may be a station that communicates with the UEs and may also be referred to as an evolved node B (eNB), a next generation eNB (gNB), an access point, and the like. Each base station 305 may provide communication coverage for a particular geographic area. In 3GPP, the term “cell” may refer to this particular geographic coverage area of a base station or a base station subsystem serving the coverage area, depending on the context in which the term is used. In implementations of wireless network 300 herein, base stations 305 may be associated with a same operator or different operators (e.g., wireless network 300 may include a plurality of operator wireless networks). Additionally, in implementations of wireless network 300 herein, base station 305 may provide wireless communications using one or more of the same frequencies (e.g., one or more frequency bands in licensed spectrum, unlicensed spectrum, or a combination thereof) as a neighboring cell. In some examples, an individual base station 305 or UE 315 may be operated by more than one network operating entity. In some other examples, each base station 305 and UE 315 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 3, base stations 305d and 305e are regular macro base stations, while base stations 305a-305c are macro base stations enabled with one of three-dimension (3D), full dimension (FD), or massive MIMO. Base stations 305a-305c take advantage of their higher dimension MIMO capabilities to exploit 3D beamforming in both elevation and azimuth beamforming to increase coverage and capacity. Base station 305f is a small cell base station which may be a home node or portable access point. A base station may support one or multiple (e.g., two, three, four, and the like) cells.

Wireless network 300 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 315 are dispersed throughout the wireless network 300, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology.

Some non-limiting examples of a mobile apparatus, such as may include implementations of one or more of UEs 315, include a mobile, a cellular (cell) phone, a smart phone, a session initiation protocol (SIP) phone, a wireless local loop (WLL) station, a laptop, a personal computer (PC), a notebook, a netbook, a smart book, a tablet, a personal digital assistant (PDA), and a vehicle. Although UEs 315a-j are specifically shown as vehicles, a vehicle may employ the communication configuration described with reference to any of the UEs 315a-315k.

In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 315a-315d of the implementation illustrated in FIG. 3 are examples of mobile smart phone-type devices accessing wireless network 300. A UE may also be a machine specifically configured for connected communication, including machine type communication (MTC), enhanced MTC (eMTC), narrowband IoT (NB-IoT) and the like. UEs 315e-315k illustrated in FIG. 3 are examples of various machines configured for communication that access wireless network 300.

A mobile apparatus, such as UEs 315, may be able to communicate with any type of the base stations, whether macro base stations, pico base stations, femto base stations, relays, and the like. In FIG. 3, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 300 may occur using wired or wireless communication links.

In operation at wireless network 300, base stations 305a-305c serve UEs 315a and 315b using 3D beamforming and coordinated spatial techniques, such as coordinated multipoint (CoMP) or multi-connectivity. Macro base station 305d performs backhaul communications with base stations 305a-305c, as well as small cell, base station 305f. Macro base station 305d also transmits multicast services which are subscribed to and received by UEs 315c and 315d. Such multicast services may include mobile television or stream video, or may include other services for providing community information, such as weather emergencies or alerts, such as Amber alerts or gray alerts.

Wireless network 300 of implementations supports mission critical communications with ultra-reliable and redundant links for mission critical devices, such UE 315e, which is a drone. Redundant communication links with UE 315e include from macro base stations 305d and 305e, as well as small cell base station 305f. Other machine type devices, such as UE 315f (thermometer), UE 315g (smart meter), and UE 315h (wearable device) may communicate through wireless network 300 either directly with base stations, such as small cell base station 305f, and macro base station 305e, or in multi-hop configurations by communicating with another user device which relays its information to the network, such as UE 315f communicating temperature measurement information to the smart meter, UE 315g, which is then reported to the network through small cell base station 305f. Wireless network 300 may also provide additional network efficiency through dynamic, low-latency TDD communications or low-latency FDD communications, such as in a vehicle-to-vehicle (V2V) mesh network between UEs 315i-315k communicating with macro base station 305c.

In the field of autonomous driving and perception systems, multiple sensors, such as LiDAR, camera, and radar, are used to more accurately recognize and track objects in all conditions. The result of the object recognition and tracking are then used as inputs to an autonomous driving and/or to an autonomous driving related perception and sensor sharing system, such as for transmission of wireless communication with sensor sharing information. Additionally, the outputs of the individual sensors may be “fused” or combined and used as a single input to increase the accuracy and reliability of the output. Accurate integration of the outputs from the multiple poses a unique challenge for accurate and reliable object detection.

For example, there may be differences in the determined or detected motion for object between these sensors, due to their inherent characteristics and physical setups. These differences in the outputs of the sensors can introduce temporal misalignments in the captured data, which hinders the effectiveness of object detection algorithms and/or object tracking algorithms, and ultimately the inputs on which automated driving algorithms are using for controlling the vehicle and which sensor sharing algorithms are using to warn other vehicles, devices and people.

To illustrate, the temporal misalignment often stems from two primary sources, motion of the sensors themselves and motion of the objects. The temporal misalignment from the motion of the sensors themselves includes temporal misalignment from changes in position/pose of the sensor device (e.g., vehicle) while it is recording the sensor data. The temporal misalignment from the motion of the objects includes temporal misalignment from misalignment/mismatch of sensor data due to the movement of the objects in the environment.

There are several systems that the vehicle can employ to adjust for motion of the sensors and to compensate for or reduce temporal misalignment due to motion of the vehicle and sensors. For example, inertial and/or navigational devices (e.g., inertial sensors, GPS, etc.) and corresponding algorithms that address or correct for motion of the sensors. To illustrate, GPS/Inertial Navigation System (INS) may be used to compensate for vehicle motion.

Additionally, the vehicle may use other sensors and/or techniques to adjust for object motion and compensate for or reduce temporal misalignment due to object motion. For example, point-cloud registration and optical flow analysis may be used to compensate or adjust for object motion. However, the object motion compensation suffers several drawbacks due to the inaccuracies in the object velocities inferred from the mentioned techniques and due to some sensor limitations. For example, LiDAR and camera velocity estimation has lower accuracy than radar for velocity estimation.

In the aspects described herein, methods and systems are described that utilize the increased accuracy in velocity estimation capability of radar sensor to more effectively fuse or combine sensor data from multiple types across time for improved accuracy and downstream performance in object detection and/or tracking, and ultimately resulting in improved autonomous driving and perception/sensor sharing systems.

In one aspect, a device receives synchronized data from multiple sensors, such as radar, LiDAR, and cameras, which captures the surrounding environment at the same time. The received sensor data is synchronized, such as with timestamps, to ensure temporal alignment for accurate motion compensation.

The sensors data is then processed to remove noise and artifacts, and to calibrate the sensors. The device then performs coordinate system alignment to ensure consistency across sensor modalities.

The sensor data, once aligned, may be encoded after alignment. In the LiDAR pipeline, the system may extract the 3D features by passing through a voxel encoder to voxelize the 3D sparse LiDAR features. The sparse lidar features may then be flattened to produce LiDAR Bird's Eye View (BEV) features. In the camera pipeline the camera images are encoded and “lifted” to a 3D space from the two dimensional image space, and the 3D feature vectors maybe compressed to BEV features. The radar sensor data may be similarly processed to convert radar features to BEV features. The feature data from the different sensors may then be fused based on velocity information from a radar scene flow.

To generate the radar scene flow and estimate the motion thereof, the system may process two consecutive point clouds P and Q captured by the radar system to estimate a set of 3D vectors S that represent the displacement of each point in P to its corresponding position x0i in the scene described by Q. Each point in the radar point clouds contains 3D positional information (xi, yi) as well as additional 3D features (fi, gi) such as radial relative velocity (RRV), radar cross-section (RCS), and power measurement. These features provide semantic and motion clues about the objects in the scene.

The system voxelizes the radar point clouds with the same strategy as LiDAR and camera features for geometric alignment. Alongside the occupancy information, we encode the velocity information within each voxel. The system can calculate the magnitude of the velocity, based on the velocity components, such as Vx and Vy, for each radar point. The system can then normalize the magnitude to fit within a predefined range, such as [0, 1].

The system may then process the radar point cloud with velocity information to generate a scene flow (scene flow parameter information) which is used to guide fusion of the different sensor data.

The system combines or concatenates the feature information from the different sensors based on the radar scene flow information using a spatio-temporal conditional attention technique. For example, the LiDAR, camera, and radar features (of the respective feature information) for each voxel are combined using voxel position refinement and/or aggregation information derived from the radar scene flow parameters over time.

This fusion step allows the features to capture both spatial information from LiDAR and semantic details from the camera, while incorporating the motion information from the radar scene flow. The features are aggregated over time to capture the spatio-temporal patterns and refine the features. The fused features which better account for object motion may be processed (e.g., decoded or transformed) and provided as input information for object detection and tracking. The object detection and tracking may have improved results based on the improved fusion of the senor data that was based on the more accurate velocity information from the radar scene flow information.

The improved object detection and tracking information may then be provided to autonomous driving and/or collective perception systems which utilize the improved data to provide safer autonomous driving and more accurate object notifications.

In the aspects described herein, complementary information is used to increase device perception. For example, radar, LiDAR, and cameras may each provide unique information about the environment. To illustrate, radar and LiDAR may penetrate and provide information which cannot be observed visually, but cameras may provide more information for object detection/recognition in clear conditions and radar may provide more information for detecting objects in adverse weather conditions (e.g., rain, fog, etc.). Additionally, the speed or cycle time of radar systems (emission and capture) and the type of electromagnetic radiation used for detection provides for increased accuracy in estimating relative velocities of objects. By combining these modalities, the system can leverage their complementary strengths and overcome their individual limitations. By fusing the sensor data, the system creates a more robust perception system that is resilient to varying environmental conditions.

In the aspects described herein, radar sensor information can be used to improve object detection and tracking. For example, radar provides accurate velocity measurements in varying condition, which can enhance object detection and tracking. By incorporating radar scene information with feature information from other sensors (e.g., LiDAR and camera feature information), the system can improve the accuracy of object motion estimation. This leads to better predictions of object trajectories and enables more reliable object tracking over time.

In the aspects described herein, autonomous driving system performance is improved in challenging scenarios, such as inclement or adverse weather. For example, current autonomous driving systems which rely on unfused or combined sensor information and/or which do not utilize multiple sensors often have reduced performance when objects are visually occluded and/or low-light conditions. Radar can penetrate obstacles and detect objects that may be partially or fully obscured from LiDAR or cameras. Integrating radar scene information helps overcome these limitations of other sensors and provides a more complete perception of the surrounding environment.

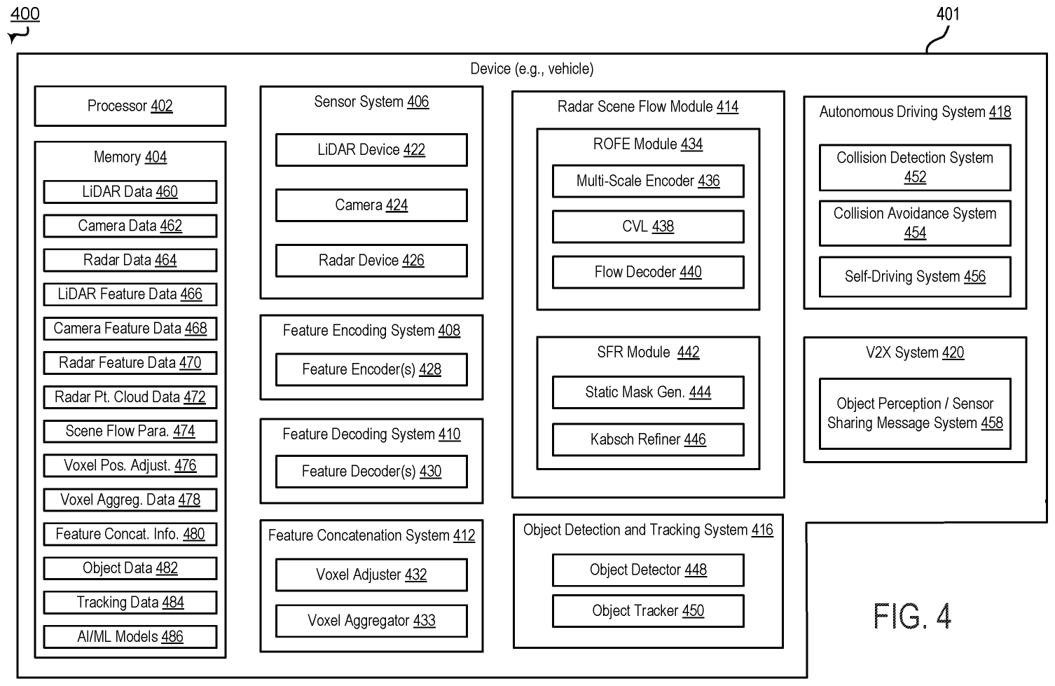

FIG. 4 illustrates an example 400 of a device 401 that supports enhanced sensor fusion operations in accordance with aspects of the present disclosure. In some examples, the device 401 may include or correspond to the vehicle 100 of FIG. 1, including the components of FIG. 2. For example, the device 401 may include a processing system with sensors that detect and track objects and a wireless communication system to interact with a wireless communication network, as illustrated in FIG. 3. The wireless communication network may include or correspond to a V2X network. The V2X network may include multiple wireless devices, such as UEs (e.g., UE 115).

Device 401 may be configured to communicate via one or more portions of the electromagnetic spectrum. For example, the device 401 may be configured to communicate via one or more portions of the electromagnetic spectrum associated with Bluetooth transmissions, Wi-Fi transmissions, or cellular transmissions (including sub-6 GHz and 6 GHz).

Device 401 may be configured to communicate via one or more channels or component carriers (CCs). Each channel or CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more channels or CCs may have or be assigned to a Cell ID, or a Bandwidth Part (BWP) ID. The Cell ID may include a unique cell ID for the channel or CC, a virtual Cell ID, or a particular Cell ID of a particular channel or CC of the plurality of channels or CCs. Additionally, or alternatively, one or more channels or CCs may have or be assigned to a HARQ ID. Each channel or CC may also have corresponding management functionalities, such as, beam management or BWP switching functionality. In some implementations, two or more channels or CCs are quasi co-located, such that the channels or CCs have the same beam and/or same symbol.

In some implementations, control information may be communicated by network devices (e.g., a base station 105) to the device 401. For example, the control information may be communicated using Bluetooth transmissions, Wi-Fi transmission, MAC-CE transmissions, RRC transmissions, DCI (downlink control information) transmissions, UCI (uplink control information) transmissions, SCI (sidelink control information) transmissions, another transmission, or a combination thereof.

Device 401 can include a variety of components (e.g., structural, hardware components) used for carrying out one or more functions described herein. For example, these components can include a processing system and memory configured to perform enhanced sensor fusion operation and improved object detection and tracking, along with wireless communication components, such as a transceiver, an encoder, a decoder, and one or more antennas (not shown in FIG. 4 for simplicity).

As illustrated in the example of FIG. 4, the device (e.g., vehicle) 401 includes a processor 402 and a memory 404. Processor 402 may be configured to execute instructions stored at memory 404 to perform the operations described herein. In some implementations, processor 402 includes or corresponds to the processing system and/or the processor 204 of FIG. 2, and memory 404 includes or corresponds to the memory 206 of FIG. 2. Memory 404 may also be configured to store information and data for enhanced sensor fusion operations, improved object detection and tracking, autonomous driving operations, V2X notifications operations, or a combination thereof, as further described herein.

For example, the memory 404 may be configured to store one or more of LiDAR data 460, camera data 462, radar data 464, LiDAR feature data 466, camera feature data 468, radar feature data 470, and radar point cloud data 472.

The LiDAR data 460 may include or correspond to voxel data for multiple LiDAR frames in an image space, and the LiDAR feature data 466 may include or correspond to voxel data which corresponds to the voxel data of the LiDAR sensor data which has been converted (e.g., lifted or transformed) to another type of image space, such as a BEV feature space. Similarly, the camera data 462 may include or correspond to voxel data for multiple camera frames in an image space, and the camera feature data 468 may include or correspond to voxel data which corresponds to the voxel data of the camera sensor data which has been converted (e.g., lifted or transformed) to another type of image space, such as a BEV feature space. Also, the radar data 464 may include or correspond to voxel data for multiple radar frames in an image space, and the radar feature data 470 may include or correspond to voxel data which corresponds to the voxel data of the radar sensor data which has been converted (e.g., lifted or transformed) to another type of image space, such as a BEV feature space.

As the feature data from the different sensors is encoded or converted to a common feature space for multiple the sensors, the feature data from the different sensors may be combined. For example, the feature data for LiDAR, camera, and radar may be combined. However, combining voxel information (e.g., the feature information associated with each voxel) for each sensor directly may introduce errors, because there will be some temporal misalignment between the sensor data due to device motion (e.g., changes in position and/or pose) and object motion. The feature data may be combined based on voxel aggregation information 478 and/or voxel adjustment information (e.g., voxel position adjustment data 476) which is derived from radar scene flow parameter data 474. The radar scene flow parameter data 474 is generated from the radar point cloud data 472.

The radar point cloud data 472 may include or correspond to a portion of the received radar sensor data or to processed radar sensor data. The radar point cloud data 472 may include point cloud information for multiple radar frames. The point cloud information may include voxel information association with each point of the point cloud. Processing two frames of the radar point cloud data 472 may enable accurate object motion estimation for sensor fusion, object tracking, and ultimately autonomous driving and/or V2X operations.

Additionally, or alternatively, the memory 404 may also be configured to store one or more of scene flow parameter data 474, voxel position adjustment data 476, voxel aggregation data 478, feature concatenation information 480, object data 482, tracking data 484, and AI/ML model data 486.

The scene flow parameter data 474 may include or correspond to information regarding the flow of objects in a scene. For example, the scene flow parameter data 474 may include object motion information, such as velocity or vector information for points or objects in a scene between two frames, such as the motion from frame-to-frame. In some implementations, the scene flow parameter data 474 includes multiple types of scene flow parameter data, such as initial and final scene flow parameter data, or coarse, fine (e.g., rigid), and refined scene flow parameter data.

The voxel position adjustment data 476 may include or correspond to information regarding voxel position adjustments for voxels of the feature data based on the flow of objects in a scene from the scene flow parameter data 474. For example, the voxel position adjustment data 476 may include voxel position adjustment information which indicates a new position for a point of an object and corresponding voxels in the feature data or which indicates a position difference or delta for a point of an object and corresponding voxels in the feature data.

The voxel aggregation data 478 may include or correspond to information regarding aggregation or combination of voxels for voxels of the feature data based on the flow of objects in a scene from the scene flow parameter data 474, and optionally the voxel position adjustment data 476. For example, the voxel aggregation data 478 may include voxel aggregation information which indicates which voxels of the different feature data correspond to a particular point of an object in the scene.

The feature concatenation information 480 may include or correspond to information regarding fused sensor data for use in object detection and tracking feature. For example, the feature concatenation information 480 may include adjusted and aggregated voxel information which is based on the voxel information of two or more sensors. To illustrate, the feature concatenation information 480 may include a plurality of voxels which include feature information which has been concatenated, aggregated, or combined from the feature data of the different sensors based on the scene flow parameter data 474, such as the voxel position adjustment data 476 and/or the voxel aggregation data 478 thereof. The adjusted and aggregated voxel information may include voxels which have a different position, a different velocity, a different timestamp, correspond to a different point on an object, or a combination thereof, from the corresponding voxels of the feature data from the different sensors.

The object data 482 includes or corresponds to output data from performing object detection operations using fused sensor data, such as the feature concatenation information 480. The object data 482 may include object detection data which indicates a type or class of detected object (e.g., person, pedestrian, car, sign, lane, etc.), a status of the detected object (e.g., moving, stationary, fast, slow, driving, etc.), a location of the detected object (e.g., bounding box information).

The tracking data 484 includes or corresponds to output data from performing object tracking operations using fused sensor data, such as using the object data 482, which was generated based on the feature concatenation information 480, and optionally the feature concatenation information 480 (e.g., the velocity or movement related information thereof). The tracking data 482 may include object tracking data which indicates a direction or heading of detected objects, and a speed of detected objects.

The AI/ML model data 486 includes or corresponds to AI or ML models for one or more systems or modules of the device 401. For example, the device 401 may include a single AI or ML model for the object detection and tracking operations, such as a single AI or ML model associated with one or more of the sensor system 406, the feature encoding system 408, the feature decoding system 410, the feature concatenation system 412, the radar scene flow module 414, and the object detection and tracking system 416. To illustrate, the AI or ML model for the object detection and tracking operations may receive sensor data as input and output object detection and/or tracking information. Additionally, or alternatively, the AI/ML model data 486 may include separate individual modules for different components. For example, the AI/ML model data 486 may include one or more AI or ML modules for autonomous driving used by the autonomous driving system 418. As another example, the object detection and tracking operations may include multiple discrete AI or ML modules for different portions of the object detection and tracking operations. To illustrate, the device 401 may include an AI or ML module for radar scene flow estimation by the radar scene flow module 414, an AI or ML module for feature concatenation by the feature concatenation system 412, an AI or ML module for object detection by the object detector 448, and an AI or ML module for object tracking by the object tracker 450.

The device 401 further includes a sensor system 406 including one or more different sensors. The sensors of the sensor system 406 may include or correspond to the sensors described with reference to FIG. 3. As illustrated in the example of FIG. 4, the device 401 includes a LIDAR device 422, a camera 424, and a radar device 426. The LiDAR device 422 may include or correspond to a LiDAR sensor or system of LiDAR sensors configured to generate LiDAR sensor data, such as the LiDAR data 460. The camera 424 may include or correspond to an optical sensor or system of optical sensors configured to generate optical data, such as the camera data 462. The radar device 426 may include or correspond to a radar sensor or system of radar sensors configured to generate radar sensor data, such as the radar data 464.

The device 401 further includes a feature encoding system 408 including one or more feature encoders 428. The feature encoders 428 may be configured to generate encoded data in a feature space, such as feature data, based on received sensor data from the sensor system 406. For example, the first feature encoder (e.g., a LiDAR feature encoder) may generate feature data based on received sensor data from a first sensor of the sensor system 406. As an illustrative, non-limiting example, the feature space may include or correspond to a birds-eye-view (BEV) feature space and the feature data may indicate information regarding features of the BEV feature space. To illustrate, features may be “lifted” from two-dimensional sensor/image planes to a three-dimensional plane and/or BEV plane.

In the example of FIG. 4, the device 401 may include a first feature encoder (e.g., a LiDAR feature encoder), a second feature encoder (e.g., a camera feature encoder), and a third feature encoder (e.g., a radar feature encoder). To illustrate, the LiDAR feature encoder generates LiDAR feature data, such as the LiDAR feature data 466, based on the LiDAR sensor data, such as the LiDAR data 460, the camera feature encoder generates camera feature data, such as the camera feature data 468, based on the camera sensor data, such as the camera data 462, etc.

The device 401 further includes a feature decoding system 410 including one or more feature decoders 430. The feature decoder(s) 430 may be configured to decode data in a feature space, such as aggregated or fused feature data, from the feature concatenation system 412. For example, a feature decoder may generate fused decoded data in a particular image or feature space based on the feature concatenation information 480 from the feature concatenation system 412. As another example, a first feature decoder (e.g., a fused feature decoder) may generate decoded fused data in an image space based on the feature concatenation information 480 from the feature concatenation system 412 for use in the object detection and tracking system 416.

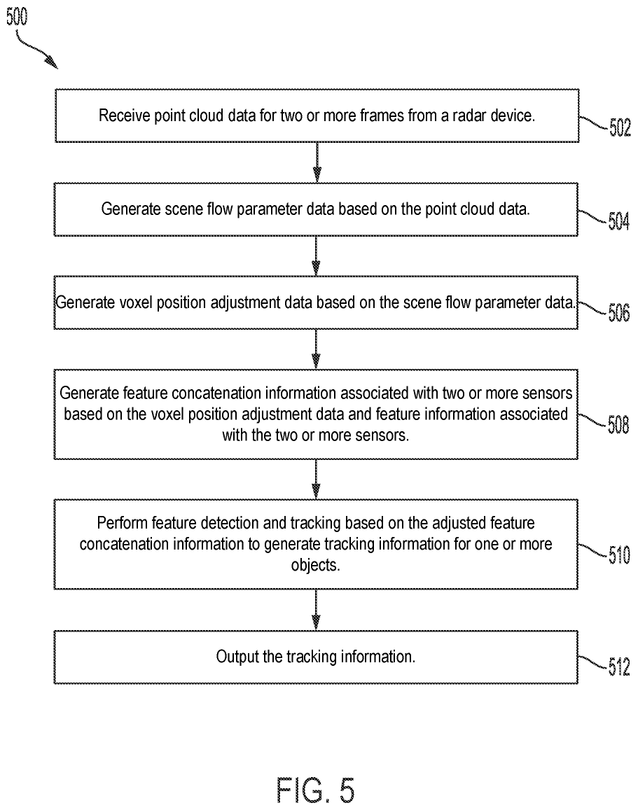

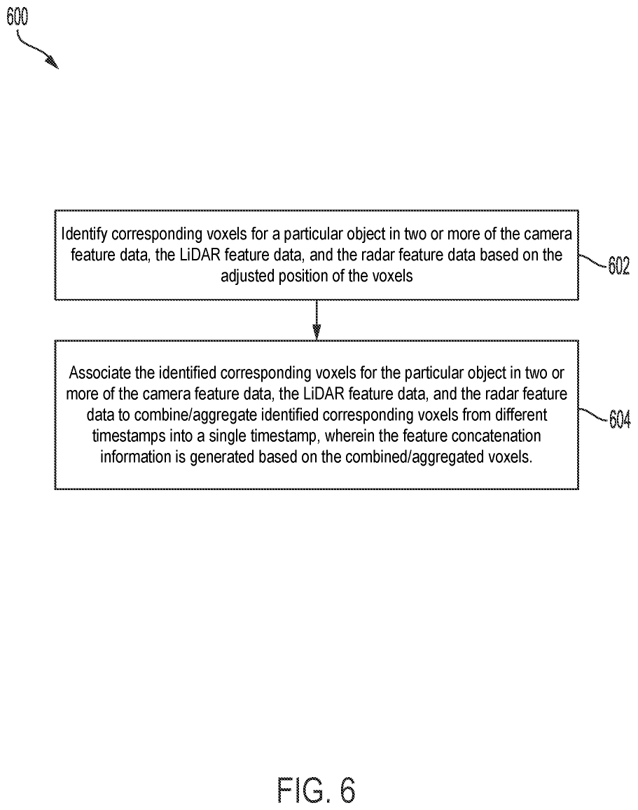

The device 401 further includes a feature concatenation system 412 for including a voxel adjuster 432 and a voxel aggregator 433. The feature concatenation system 412 is configured to generate the feature concatenation information 480 based on the received feature information from two or more different sensors and based on the scene flow information, scene flow parameter data 474. The voxel adjuster 432 may be configured to adjust positions of voxels from the feature data based on velocity information from the radar scene flow information. The voxel aggregator 433 may be configured to combine or concatenate voxels, such as the feature information thereof, across the feature information of the different sensors. Additional details on feature concatenation are described with reference to FIGS. 5 and 6.

The device 401 further includes a radar scene flow module 414 including a ROFE module 434 and a SFR module 442. The radar scene flow module 414 is configured to generate scene flow parameter information, scene flow parameter data 474, based on radar sensor data, radar data 464. The scene flow parameter information is generated to account for object motion and can be used during sensor fusion (feature information concatenation) to generate feature concatenation information.

The ROFE module 434 may be configured to generate scene flow information, such as initial scene flow information or coarse scene flow information. The scene flow information generated by the ROFE module 434 may represent unconstrained flow vector information for points in the scene based on the radar point cloud data. For example, the ROFE module 434 receives point cloud data for two frames, such as point clouds P and Q, and estimates a coarse scene flow Sc, which represents the unconstrained flow vectors for each point in the point clouds.

The ROFE module 434 may include one or more sub-modules, such as a multi-scale encoder 436, a cost volume layer (CVL) module 438, and a flow decoder 440. The multi-scale encoder 436 may be configured to generate local and global feature information from radar point cloud information. For example, the multi-scale encoder 436 may be configured to extract local and global features from pairs of radar point clouds for two consecutive frames using multiple convolutional layers with different radii.

The CVL module 438 may be configured to generate correlated feature information based on local and global feature information. For example, the CVL module 438 may be configured to correlate features across frames by aggregating costs in patches, such as by using patch-to-patch similarity comparison techniques. To illustrate, the CVL module 438 may receive the local and global feature information and the point cloud information and may compare the similarity of the features to generate correlated featured information.

To generate or decode the flow estimation from the correlated feature information, the correlated feature information may be decoded by the flow decoder 440. The flow decoder 440 may be configured to generate flow estimation information based on the correlated feature information. For example, the flow decoder 440 may be configured to decode the correlated feature information based on the correlated feature information, the local and global feature information, and the radar point cloud information. To illustrate, the flow decoder 440 may determine the flow embedding information by concatenating correlated, local-global, and input features of the voxelized radar point cloud P. The flow embedding information may include or correspond to concatenate point cloud input information, correlated feature information, and global feature information.

The ROFE module 434 may be configured to generate the scene flow information based on the flow embedding information. For example, the multi-scale encoder 43 or a second multi-scale encoder may be used with the flow embedding and point cloud P to group embedded features of scene flow and include spatial smoothness for the ROFE module 434 output. The resulting grouped features (U) are obtained from the multiple convolutional layers. The grouped feature information indicating the grouped feature may be input into a decoder or neural network, such as MLP (Multi-Layer Perceptron). For example, a four-layer MLP may process the grouped feature information to generate the coarse scene flow (Sc. i.e., Sc=θU), where θ denotes the MLP, and where Sc is the initial radar scene flow estimate.

Because of the sparsity of points and potential noise in radar data, the scene flow estimated by the ROFE module 434 may be further refined in some implementations to provide an improved scene estimation, or specifically more accurate object motion. The scene flow estimation output by the ROFE module 434 may be referred to as a coarse-grained estimation which can be refined further based on additional processing operations, such as static flow refinement operations.

The SFR module 442 may be configured to perform static flow refinement operations. The static flow refinement operations may regularize the flow vectors of static points (e.g., background or non-object points) by applying a rigid transformation respective to the motion of the device 401 and the radar device 426 thereof.

The SFR module 442 may include one or more sub-modules, such as a static mask generator 444 and a Kabsch refiner 446. The static mask generator 444 is configured to generates a static mask which indicates or corresponds to a set of points in the scene which are static. For example, the static mask generator 444 may utilize a threshold (e.g., movement threshold) to determine whether a particular point in a scene has moved from frame to frame. The threshold may include or correspond to the motion of the device 401, to account for motion of the sensors and to capture whether there was any relative motion of the points (and objects) in the scene to determine which points correspond to the static background. The static mask, static mask information, may include or correspond to a matrix with zeros representing moving points and ones representing static points.

The Kabsch refiner 446 is configured to generate global rigid transformation information for use in generating static or rigid scene flow information. For example, the Kabsch refiner 446 estimates a global rigid transformation matrix (Tcr) using a differentiable Kabsch algorithm. The Kabsch refiner 446 may use or apply the differentiable Kabsch algorithm to compute the centered point coordinates of two sets of paired points by subtracting the centroid coordinates. The optimal rotation matrix (global rigid transformation matrix Tcr) is then solved through a singular value decomposition of a centroid difference of matched points, and the translation vector is restored by comparing the centroid coordinates of matched points of a frame after applying the rotation matrix.

The SFR module 442 may utilize relative velocity information for determination of static points. For example, four dimensional (4-D) radars provide Radial Relative Velocity (RRV) measurements that describe the moving speed of ambient objects relative to the observer in the radial direction, and such may be used to determine which points are static relative to the device 401, even when the device 401 is moving with speed. RRV measurements of a point cloud P are denoted as VPr, where vir is positive when voxel point xi is moving away from the observation point. RRV measurements can be used as input features to include point-level motion cues.

In some implementations, the system may assume the velocity of voxel point xi remains constant (i.e., no acceleration) during the time interval Δt between two radar scans, as radar frames have low latency. According to this assumption, the projection of the flow vector on the radial direction is equal to the measured RRV multiplied by the Δt. The constant velocity assumption introduces little to no error because the time interval between radar scans is usually very short, and the average velocity of the points can approximate the instantaneous velocity in most cases. RRV enables the self-supervised learning framework to operate and improve and learn even without the availability of training information, such as a true or truth scene flow. In some implementations, the acceleration of the device 401 during the time interval is known, and such information can also be used to so that the assumption also does not relay on a constant velocity assumption for the device 401.

Weighting static points higher in the loss function for the SFR module 442 can help focus the refinement more on the background. The SFR module 442 may be configured to achieve this focus by applying weights to the loss function when computing the error between the initial coarse flow Sc and refined flow Sf for each radar point, by the equation L=ΣMs(i)·┌Sc(i)−Sf(i)┌, Where: L is the total loss, i denotes the index for each radar point, Ms is the static point mask (1 for static, 0 otherwise), and Sc(i)−Sf(i) denotes the Euclidean norm (also known as the magnitude or length) of the vector difference between Sc(i) and Sf(i).

By multiplying the static mask Ms, the loss contribution is weighted higher for points labeled as static. The mask Mscan come from thresholding the RRV, such as by the following equation:

$${M}_{s} ( i ) = \{ 1 if \vert RRV ( i ) \vert < threshold 0 otherwise$$

This loss weighting enables the SFR module on refining the flow vectors by isolating ego-motion based on static points and object motion from dynamic points. The static mask Ms is applied to the point cloud P to get its warped counterpart Pc′. To distinguish between static and moving points, the relative residual is calculated by comparing the radial displacement induced by the intermediate rigid flow vector and the RRV measurement. The relative residual is defined as the difference between the radial displacement and the RRV measurement.

The device 401 further includes an object detection and tracking system 416 including an object detector 448 and an object tracker 450. The object detector 448 may be configured to detect objects in the decoded aggregated or fused feature data, from the feature concatenation system 412. For example, the object detector 448 may determine to generate and place bounding boxes based on the decoded feature concatenation information 480 from the feature decoding system 410, and then may identify the objects in the bounding boxes based on conventional object recognition or identification methods.

The object detector 448 generates the object information 482 based on performing object detection operations. The object information may include object position and type information. Because the decoded aggregated or fused feature data the object detector 448 receives includes voxels which have been adjusted or aggregated to account for object motion based on more accurate radar sensor information, the “modified” voxel information includes more accurate position information and more accurate object detection operations can be performed using position information from multiple sensors which has been correlated using radar information. The object information 482 is provided to the object tracker 450 for performing object tracking operations to generate tracking data 484 which indicates object motion information.

The object tracker 450 may be configured to track objects detected by the object detector 448. For example, the object tracker 450 may be configured to generate tracking data 484 (e.g., object tracking information) based on object information 482 (e.g., object detection information) received from the object detector 448. To illustrate, the object tracker 450 may be configured to generate tracking data 484 (e.g., object tracking information) which accounts for object movement based on the adjusted voxel information of the feature concatenation information 480 and based on the detected objects of the object information. Because the decoded feature concatenation information 480 includes voxels which have been adjusted or aggregated to account for object motion based on more accurate radar sensor information, the “modified” voxel information includes more accurate motion information and more accurate driving and/or notifications can be generated using this information.

The device 401 further includes an autonomous driving system 418 including one or more sub-systems or modules. As illustrated in the example of FIG. 4, the autonomous driving system 418 includes a collision detection system 452, a collision avoidance system 454, and a self-driving system 456. The autonomous driving system 418 may be configured to generate one or more outputs based on the object detection and/or motion tracking information. For example, the collision detection system 452 may determine a possible collision based on object data and/or tracking data and output a notification or indication, such as an audio indication, visual indication, haptic indication, or a multi-modal indication. As another example, the collision avoidance system 454 or the self-driving system 456 may determine a particular action or driving maneuver (e.g., rotate the wheel 30 degrees, brake, accelerate, etc.) to avoid a collision or to operate without human intervention or to fully operate the device 401 with little to no operator input.

The device 401 further includes a V2X system 420 including one or more sub-systems or modules. As illustrated in the example of FIG. 4, the V2X system 420 includes a sensor sharing system 458. The sensor sharing system 458 may be configured to wirelessly transmit one or more sensor sharing messages or TIM warning messages based on the object detection information (e.g., object data 482) and/or object tracking information (e.g., tracking data 484). For example, the sensor sharing system 458 may generate and transmit messages which indicate or identify objects to other devices. Additionally, the messages may indicate motion information for the identified objects. The messages may enable other devices to perform object detection and tracking, such as focused or more efficient object detection and tracking and/or to perform autonomous driving operations similar to those described with reference to the autonomous driving system 418.

In some implementations, the V2X system 420 is configured to receive sensor sharing messages including object detection information and/or object tracking information generated by another device, and may perform object detection and tracking, and/or autonomous driving operations based on the received object detection information and/or object tracking information.

During operation, the device 401 may perform object detection and tracking to engage in autonomous driving and/or V2X notification operations. The device 401 may fuse or combine sensor data which is used as input for the object detection and tracking operations by the object detection and tracking system 416. The resulting output of the object detection and tracking may then be provided to the autonomous driving and/or V2X system for use in performing autonomous driving and/or V2X notification operations. Because the sensor fusion was performed with radar scene flow information, the fused sensor data has improved accuracy as compared to conventional fused sensor systems and systems which rely on one type of sensor. Detailed operations of the device 401, are described further with reference to FIGS. 5-8.

Accordingly, the device 401 may be able to perform improved object detection and tracking operations by utilizing the enhanced sensor fusion techniques described herein. Accordingly, the device 401 performance and user experience may be increased due to enhanced autonomous driving operations and/or enhanced V2X operations due to improved object detection and tracking information.

Referring to FIG. 5, FIG. 5 is a flow chart illustrating an example method 500 of enhanced sensor fusion according to one or more aspects of the disclosure. The method 500 may be performed by one or more of the devices or components described herein. For example, the operations of method 500 may be performed by the vehicle 100 of FIG. 1, the processing system of FIG. 2, or the device 401 of FIG. 4.

At 502, the method includes receiving point cloud data for two or more frames from a radar device. For example, the radar device 426 generates radar sensor data over a period of time, and the radar sensor data includes point cloud data for two or more frames. As another example, the radar device 426 generates radar sensor data and provide the radar sensor data (e.g., radar azimuth and Doppler data) the radar scene flow module 414 generates point cloud information based on the received radar sensor data. The radar point cloud data may be generated from a radar device which include a plurality of radar sensors or from multiple radar devices.

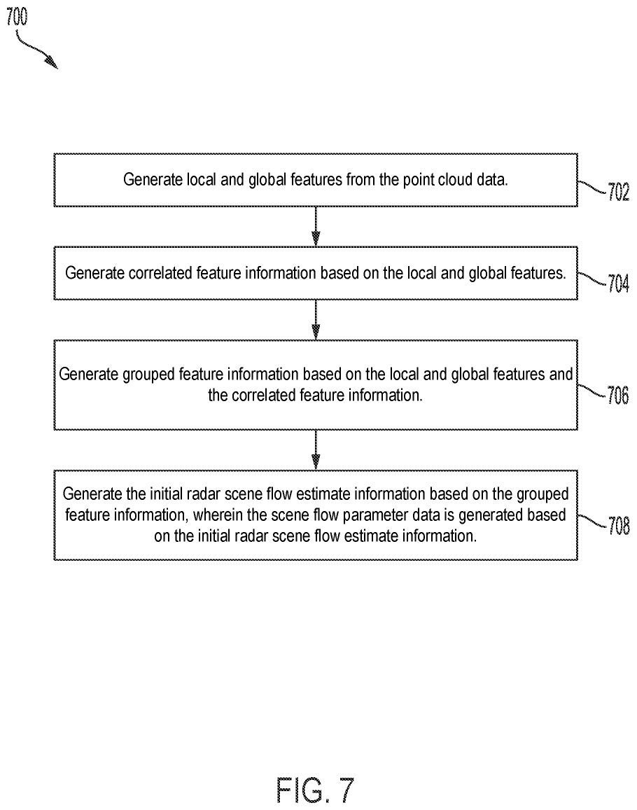

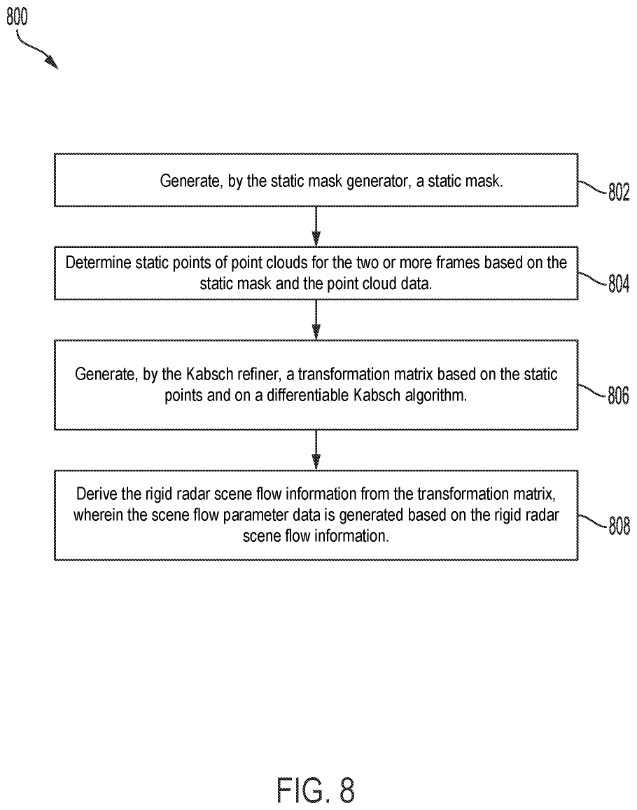

At 504, the method includes generating scene flow parameter data based on the point cloud data. For example, the radar scene flow module 414 generates scene flow parameter data for the two or more frames. To illustrate, the radar scene flow module 414 may generate scene flow parameter data for two consecutive frames depicting objection motion. The radar scene flow module 414 may generate the scene flow parameter data as described with reference to FIG. 4, and as described further with reference to FIGS. 7 and 8. In some implementations, the radar scene flow module 414 may generate rough or coarse scene flow data and then refine the coarse scene flow data.

For example, the ROFE module 434 receives the voxels (e.g., voxel information) from two consecutive frames of radar point clouds (P and Q) as input and estimates a coarse scene flow (S_c) which represents the unconstrained flow vectors for each point in the point cloud between the two frames. The SFR module 442 provides static flow refinement and generates fine scene flow information for combination with the coarse scene flow or generates refined scene flow information based on the coarse scene flow which represents the final scene flow information and object motion.

At 506, the method includes generating voxel position adjustment data based on the scene flow parameter data. For example, the feature concatenation system 412 or the radar scene flow module 414 generates voxel position adjustment data based on the scene flow parameter data for the two or more frames. To illustrate, the feature concatenation system 412 receives the scene flow parameter data for two or more frames the radar scene flow module 414 and generates voxel position adjustment data for the two or more frames based on the scene flow parameter data. The voxel position adjustment data may be used to adjust voxels of other sensors (e.g., voxels of LiDAR, camera, and/or radar feature data) and/or to combine, aggregate, or correlated voxels of different sensors and/or timestamps.

At 508, the method includes generating feature concatenation information associated with two or more sensors based on the voxel position adjustment data and feature information associated with the two or more sensors. For example, the feature concatenation system 412 generates feature concatenation information based on the voxel position adjustment data for the two or more frames. To illustrate, the voxel adjuster 432 may adjust a position, velocity, or timestamp of or associated with a voxel of one or more of the camera feature data, the LiDAR feature data, or the radar feature data. As another illustration, the voxel aggregator 433 may combine, aggregator or correlate voxels corresponding to the same object (e.g., same point on the object) from different sensors and/or having different timestamps. The feature concatenation information may be generated by using a temporal approach, such as the spatio-temporal Conditional Attention approach as described with reference to FIG. 4, and as described further with reference to FIG. 6.

At 510, the method includes performing feature detection and tracking based on the feature concatenation information to generate tracking information for one or more objects. For example, the object detection and tracking system 416 generates object tracking information based on performing object detection and/or object tracking based on the feature concatenation information. To illustrate, the object detector 448 may utilize the adjusted voxel information (e.g., adjusted position information) to detect objects, such as determine where to place bounding boxes for objects and to recognize an object or objects within the bounding boxes. As another illustration, the object tracker 450 may utilize the adjusted voxel information (e.g., adjusted position and/or velocity information) to determine the speed and direction of detected objects from the object detector 448.

At 512, the method includes outputting the tracking information. For example, the object detection and tracking system 416 outputs the object tracking information to the autonomous driving system 418 for use as an input or the V2X systems 420 for transmission via collective perception or sensor sharing message. The autonomous driving system 418 may use the object tracking information for use in collision detection, collision avoidance, and/or self-driving. The V2X systems 420 may use the object detection and/or tracking information for transmission via collective perception or sensor sharing messages to other V2X devices, such as UE and/or vehicles.

Accordingly, devices may perform enhanced sensor fusion operations utilizing radar scene flow information to enable improved object detection and tracking operations. Accordingly, the device and network performance and user experience may be increased due to improved autonomous driving operations and/or improved V2X object notifications.

Referring to FIG. 6, FIG. 6 is a flow chart illustrating an example method 600 of feature information generation operations with spatio-temporal conditional attention for enhanced sensor fusion operations according to one or more aspects of the disclosure. The method 600 may be performed by one or more of the devices or components described herein. For example, the operations of method 600 may be performed by the vehicle 100 of FIG. 1, the processing system of FIG. 2, or the device 401 of FIG. 4. To illustrate, the operations of method 600 may be performed by the feature concatenation system 412 of FIG. 4, including the voxel adjustor 432 and/or the voxel aggregator 433 thereof.

At 602, the method 600 includes identifying corresponding voxels for a particular object in two or more of the camera feature data, the LiDAR feature data, and the radar feature data based on the adjusted position of the voxels. For example, the feature concatenation system 412 may identifying corresponding voxels for a particular point or for multiple points of an object in two or more of the camera feature data, the LiDAR feature data, and the radar feature data based on the adjusted position of the voxels. To illustrate, the feature concatenation system 412 may utilize timestamp information and voxel position information to identify which voxels of the feature data from the different sensors correspond to the same object or point on the object.

In some implementations, the feature concatenation system 412, such as the voxel adjustor 432 thereof may adjust the voxel position of the voxels based on the scene flow parameter data 474, such as the voxel position adjustment data thereof, before identifying the corresponding voxels from the different sensors in the feature data. For example, the feature concatenation system 412 may use the adjusted voxel position in each feature set for identifying which voxels should be combined and/or how such voxels should be combined.

At 604, the method 600 includes associating the identified corresponding voxels for the particular object in two or more of the camera feature data, the LiDAR feature data, and the radar feature data to combine/aggregate identified corresponding voxels from different timestamps into a single timestamp, wherein the feature concatenation information is generated based on the combined/aggregated voxels.

For example, the feature concatenation system 412 associates the identified corresponding voxels for the particular object in two or more of the camera feature data, the LiDAR feature data, and the radar feature data based on the identifying at 602 to combine or aggregate identified corresponding voxels from different timestamps into a fused or aggregate voxel of with a single timestamp.

In some implementations, the feature concatenation system 412 may receive timestamp information with the sensor/feature data and modify or weight the features based on the timestamp information. To illustrate, a timestamp encode may encode the timestamp information to generate temporal context information. The feature concatenation system 412 may adjust the timestamp information of one or more of the sensor feature data and weight the corresponding features information based on the temporal context information.

As an illustrative example, the normalized coordinate features (Fcoord) captures the spatial location of each voxel and allows specializing attention based on where features are in space. A temporal encoder (Ftime) encodes the timestamp of the sensor captures. This provides temporal context for weighting features. The radar scene flow provides ego-motion compensated velocities.

The system can modify or warp the LiDAR and camera features based on these velocities. This aligns the multi-modal features temporally to the same timestamp, and optionally to the same timestamp as the radar features. Now the system can focus its attention on spatial relationships, without mismatches in time. For example, this spatial attention can learn to fuse co-located visual and depth features. However, without velocity compensation from the radar information, these would be misaligned and unrelated in time. Thus, the system employs velocity information from the radar scene flow to capture both spatial information from LiDAR and semantic details from the camera, while incorporating the motion information from the radar scene flow. The features are aggregated over time to capture the spatio-temporal patterns and refine the features for use in object detection and tracking.

Referring to FIG. 7, FIG. 7 is a flow chart illustrating an example method 700 of ROFE module operations for enhanced sensor fusion according to one or more aspects of the disclosure. The method 700 may be performed by one or more of the devices or components described herein. For example, the operations of method 700 may be performed by the vehicle 100 of FIG. 1, the processing system of FIG. 2, or the device 401 of FIG. 4. To illustrate, the operations of method 700 may be performed by the radar scene flow module 414 of FIG. 4, including the ROFE module 434 and components thereof.

At 702, the method 700 includes generating local and global features from the point cloud data. For example, the ROFE module 434 (e.g., a multi-scale encoder 436 thereof) extracts or generates local feature data, global feature data, or both, from the received radar point cloud data. To illustrate, the multi-scale encoder 436 (e.g., feature space encoder) encodes the radar point cloud data 472 to generate local feature data and global feature data. In some implementations, the multi-scale encoder 436 encodes the radar point cloud data 472 to generate the local feature data, and the local feature data is used to generate the global feature data. For example, the local features of the local feature data may be concatenated and pooled across channels to obtain robust global features.

The local and global feature data may include or correspond to feature space data of local and global objects generated by encoding radar sensor data (point cloud data). The radar point cloud data 472 may include radar azimuth data and radar Doppler data, and may be received directly from the radar device or radar system, such as the radar device 426, or may be generated by an intermediary device, such as the radar scene flow module 414 based on received radar sensor data (e.g., radar data 464) or received radar feature data (e.g., radar feature data 470).

The multi-scale encoder 436 may employ a multi-scale grouping scheme and channel-wise max-pooling to handle the sparse nature and uneven point density of radar data. Additionally, the multi-scale encoder 436 may use multiple sets of convolutional layers associated with different radii to group multi-scale local features with different radius neighborhoods. The radii for the convolutional layers (e.g., radius neighborhoods or ring-like areas) may be specified by a set of radii. The multi-scale encoder 436 extracts multi-scale features from the radar point clouds of two different frames or timestamps, such as P and Q.

In some implementations, the multi-scale encode applies the following equation to generate the local features: F_r=σ(W_r*G(X,r)), where: F_r denotes the Local feature for radius r, W_r denotes the parameters for the set of convolutional layers, G is the Grouping operation, X is Input point cloud and σ denotes the Nonlinearity (ReLU). The local features F_r are concatenated and max pooled across channels to obtain robust global features: 1, 2, F_global=maxpool(concat(F_r1, F_r2, . . . , F_rn)).

At 704, the method 700 includes generating correlated feature information based on the local and global features. For example, the ROFE module 434 (e.g., a CVL module 438 thereof) generates correlated feature information based on the local and global features. To illustrate, the CVL module 438 extracts local and global features from the local and global features of local and global feature information and correlates the extracted features to generate correlated feature information. The correlated feature information may include or correspond to feature space data of correlated objects between the local and global features.

In some implementations, the CVL module 438 aggregates costs in a patch-to-patch manner, allowing for robust correlation of features across frames. For example, CVL module 438 aggregates patch-level similarity scores between features from the two point clouds of P and Q for two different frames at two times. An example equation for cost volume processing includes: C(p,q)=φ(F_{P} (p), F_{Q} (q)), where: (p,q) are voxel coordinates, F_{P}, F_{Q} are features for P and Q, φ is a similarity function (e.g., dot product).

The CVL module 438 applies cost volume processing to correlate features across frames in a patch-to-patch manner. After passing the point clouds and features through the CVL module 438 (e.g., a cost volume layer) correlated features are obtained.

At 706, the method 700 includes generating grouped feature information based on the local and global features and the correlated feature information. For example, the ROFE module 434 generates grouped feature information based on the local and global features and the correlated feature information. To illustrate, the multi-scale encoder 436 and the flow decoder 440 generate grouped feature information by decoding or concatenating the correlated features of the correlated feature information, the local and global features of the local and global feature information, and the input features from the radar point cloud data 472 to generate flow embedding information. The flow embedding information is encoded to group and spatially smooth the received features to generate the grouped feature information.

At 708, the method 700 includes generating the initial radar scene flow estimate information based on the grouped feature information, wherein the scene flow parameter data is generated based on the initial radar scene flow estimate information. For example, the ROFE module 434 generates the initial radar scene flow estimate information based on the grouped feature information. To illustrate, the flow decoder 440 or a neural network decoder (e.g., multiple layer perceptron) generates the initial radar scene flow estimate information by decoding the grouped feature information. The flow decoder 440 may include or correspond to a multiple layer decoder. For example, the flow decoder 440 may include or correspond to a four-layer MLP (Multi-Layer Perceptron), which receives the grouped feature information as input and which outputs coarse scene flow information.

The scene flow parameter data is generated based on the initial radar scene flow estimate information. For example, the initial radar scene flow estimate information, such as coarse radar scene flow information or parameters, may be combined with or adjusted by refined or fine radar scene flow information or parameters generated by the SFR module 442, as described with reference to FIGS. 4 and 5, and further with reference to FIG. 8.

In some implementations, to decode the flow estimation from features, the flow embedding is formed by concatenating correlated features, local and global features, and input features of the voxelized radar point cloud P. The flow embedding concatenates input, correlated and global features: E=concat(P, F_global, C).

A second multi-scale encoder may be used with the flow embedding and point cloud P to group embedding features and include spatial smoothness for the final output. The resulting grouped embedded features U are obtained from multiple sets of convolutional layers of the multi-scale encoder. The grouped embedded features U are fed into a four-layer MLP, and the output of the MLP represents the coarse scene flow, S_c, of S_c=θ(U), where denotes the MLP and S_c is the initial radar scene flow estimate.

Referring to FIG. 8, FIG. 8 is a flow chart illustrating an example method 800 of SFR module operations for enhanced sensor fusion according to one or more aspects of the disclosure. The method 800 may be performed by one or more of the devices or components described herein. For example, the operations of method 800 may be performed by the vehicle 100 of FIG. 1, the processing system of FIG. 2, or the device 401 of FIG. 4. To illustrate, the operations of method 800 may be performed by the radar scene flow module 414 of FIG. 4, including the SFR module 442 and components thereof.

At 802, the method 800 includes generating a static mask. For example, a static mask generator may generate a static mask to identify static points in a scene. To illustrate, the static mask generator 444 may use a threshold or series of thresholds to determine whether a point (e.g., a voxel and corresponding part of an object) has moved in a scene two or more frames of a point cloud. In some implementations, the static mask generator may determine whether a difference between a first position of a voxel corresponding to a point of an object and a second position of the voxel corresponding to the point of the object is greater than a threshold amount indicating movement of the object. The movement may include or correspond to relative or absolute movement. The static mask may correspond static mask information which indicates if a point has moved or not, such as 1 for static and 0 for movement). The threshold for determining whether a point (e.g., voxel) has moved may be determined based on device motion (e.g., motion of the sensor) to identify which objects have moved relative to device/sensor based on object movement and not on sensor (e.g., device or vehicle) movement.

At 804, the method 800 includes determining static points of point clouds for the two or more frames based on the static mask and the point cloud data. For example, the SFR module 442 may use (e.g., apply) a static mask (e.g., static mask information) to the radar point cloud data 472 or the preliminary or coarse scene flow parameter data received from the ROFE module 434 to determine which points in the scene are static.

At 806, the method 800 includes generating a transformation matrix based on the static points and on a differentiable Kabsch algorithm. For example, the SFR module 442 may generate a transformation matrix based on determined static points which correspond to the background or background objects of the scene and based on a Kabsch algorithm. To illustrate, the SFR module 442 generates a global rigid transformation matrix based on the identified static points of the point cloud (which were identified with the static mask) using a differentiable Kabsch algorithm.

At 808, the method 800 includes deriving the rigid radar scene flow information from the transformation matrix, wherein the scene flow parameter data is generated based on the rigid radar scene flow information. For example, the SFR module 442 may apply the transformation matrix to generate the rigid radar scene flow information. To illustrate, the SFR module 442 applies the transformation matrix to the scene flow parameters to generate the rigid radar scene flow information (e.g., refined scene flow information).

The scene flow parameter data 474 (e.g., combined or aggregated scene flow parameter data) is generated based the coarse scene flow data from the ROFE module 434 and the rigid radar scene flow information from the SFR module 442. For example, the radar scene flow module 414 generates the radar scene flow parameters based on the coarse scene flow data and the refined/rigid scene flow data. To illustrate, the radar scene flow module 414 generates the radar scene flow parameters (scene flow parameter data 474) based on combining (e.g., aggregating and/or averaging) the coarse scene flow data and the refined/rigid scene flow data or based on adjusting the coarse scene flow data based on the refined/rigid scene flow data. The radar scene flow parameters (e.g., combined, adjusted, aggregated, etc. radar scene flow parameters) is provided to the feature concatenation system 412 for voxel combining and adjusting, as described with reference to FIGS. 4-6.

The operations of any of methods of FIGS. 5-8 may be combined. For example, the operations described with reference to FIG. 6 may include or corresponds to the operations associated with or corresponding to generating feature concatenation information associated with two or more sensors based on the voxel position adjustment data and feature information associated with the two or more sensors at 508 of FIG. 5. As another example, the operations described with reference to FIGS. 7 and/or 8 may include or corresponds to the operations associated with or corresponding to generating scene flow parameter data based on the point cloud data at 504 of FIG. 5 and/or generating voxel position adjustment data based on the scene flow parameter data at 506 of FIG. 5.

In one or more aspects, techniques for supporting vehicular operations may include additional aspects, such as any single aspect or any combination of aspects described below or in connection with one or more other processes or devices described elsewhere herein. In a first aspect, a device comprises a processing system that includes processor circuitry and memory circuitry that stores code and is coupled with the processor circuitry, the processing system configured to cause the device to: receive point cloud data for two or more frames from a radar device; generate scene flow parameter data based on the point cloud data; generate voxel position adjustment data based on the scene flow parameter data; generate feature concatenation information associated with two or more sensors based on the voxel position adjustment data and feature information associated with the two or more sensors; perform feature detection and tracking based on the feature concatenation information to generate tracking information for one or more objects; and output the tracking information. In some implementations, the apparatus includes a wireless device, such as a UE. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the processing system configured to cause the device to output the tracking information includes to: provide the tracking information to an autonomous driving system; or transmit a transmission based on the tracking information.

In a third aspect, in combination with one or more of the first aspect or the second aspect, the tracking information accounts for motion of the device and for motion of the one or more objects, and wherein the voxel position adjustment data corresponds to object motion correction information for the one or more objects.

In a fourth aspect, in combination with one or more of the first aspect through the third aspect, the two or more sensors include a camera device and a LiDAR device.

In a fifth aspect, in combination with one or more of the first aspect through the fourth aspect, the two or more sensors include a camera device, a LIDAR device, and the radar device.

In a sixth aspect, in combination with one or more of the first aspect through the fifth aspect, the processing system is further configured to cause the device to: receive camera data from a camera device; perform encoding to on the camera data generate camera feature data; receive LiDAR data from a LiDAR device; perform encoding on the LiDAR data to generate LiDAR feature data; and perform encoding on the point cloud data from the radar device to generate radar feature data, and wherein the processing system configured to cause the device to generate the feature concatenation information includes to: perform feature concatenation with spatio-temporal condition attention to generate the feature concatenation information based on the camera feature data, the LiDAR feature data, the radar feature data, and the voxel position adjustment data.

In a seventh aspect, in combination with one or more of the first aspect through the sixth aspect, the processing system configured to cause the device to perform the feature concatenation with the spatio-temporal condition attention to generate the feature concatenation information includes to: adjust a voxel position of voxels in one or more of the camera feature data, the LiDAR feature data, and the radar feature data based on the voxel position adjustment data to account for motion of objects in the scene flow, wherein the feature concatenation information is generated based on the adjusted voxel position of the voxels.

In an eighth aspect, in combination with one or more of the first aspect through the seventh aspect, the processing system configured to cause the device to perform the feature concatenation with the spatio-temporal condition attention to generate the feature concatenation information further includes to: identify corresponding voxels for a particular object in two or more of the camera feature data, the LiDAR feature data, and the radar feature data based on the adjusted position of the voxels; and associate the identified corresponding voxels for the particular object in two or more of the camera feature data, the LiDAR feature data, and the radar feature data to combine (e.g., aggregate or concatenate) identified corresponding voxels from different timestamps into a single timestamp, wherein the feature concatenation information is generated based on the combined voxels.

In a ninth aspect, in combination with one or more of the first aspect through the eighth aspect, to adjust the feature concatenation information based on the voxel position adjustment data includes to: adjust a three dimensional position of one or more voxels of the feature concatenation information based on the voxel position adjustment data.

In a tenth aspect, in combination with one or more of the first aspect through the ninth aspect, the point cloud data corresponds to a radar point cloud with range doppler information and range azimuth information.

In an eleventh aspect, in combination with one or more of the first aspect through the tenth aspect, each point in the point cloud data contains three-dimensional (3D) positional information and 3D feature information, wherein 3D feature information includes radial relative velocity (RRV) information, radar cross section (RCS) information, power measurement information, or a combination thereof.

In a twelfth aspect, in combination with one or more of the first aspect through the eleventh aspect, to generate the voxel position adjustment data based on the scene flow parameter data includes to: generate scene flow parameters based on the point cloud data using a Radar Oriented Flow Estimation (ROFE) module and a Static Flow Refinement (SFR) module; and generate the voxel position adjustment data based on the scene flow parameters.

In a thirteenth aspect, in combination with one or more of the first aspect through the twelfth aspect, the ROFE module includes a multi-scale encoder, a cost volume layer, and a flow decoder, and wherein the SFR module includes a static mask generator and a Kabsch refiner.

In a fourteenth aspect, in combination with one or more of the first aspect through the thirteenth aspect, the ROFE module is configured to estimate a course scene flow based on voxel information from the point cloud and generates initial radar scene flow estimate information, wherein the SFR module is configured to refine the course scene flow to generate a final scene flow based on radial relative velocity (RRV) information from the point cloud and generates rigid radar scene flow information, and wherein the scene flow parameter data is generated based on the initial radar scene flow estimate information and the rigid radar scene flow information.

In a fifteenth aspect, in combination with one or more of the first aspect through the fourteenth aspect, the ROFE module is configured to: generate local and global features from the point cloud data; generate correlated feature information based on the local and global features; generate grouped feature information based on the local and global features and the correlated feature information; and generate the initial radar scene flow estimate information based on the grouped feature information, wherein the scene flow parameter data is generated based on the initial radar scene flow estimate information.

In a sixteenth aspect, in combination with one or more of the first aspect through the fifteenth aspect, the SFR module is configured to: generate, by the static mask generator, a static mask; determine static points of point clouds for the two or more frames based on the static mask and the point cloud data; and generate, by the Kabsch refiner, a transformation matrix based on the static points and on a differentiable Kabsch algorithm; and derive the rigid radar scene flow information from the transformation matrix, wherein the scene flow parameter data is generated based on the rigid radar scene flow information.

In a seventeenth aspect, in combination with one or more of the first aspect through the sixteenth aspect, to adjust the feature concatenation information based on the voxel position adjustment data includes to: adjust a three dimensional position of one or more voxels of the feature concatenation information based on the voxel position adjustment data.

In an eighteenth aspect, in combination with one or more of the first aspect through the seventeenth aspect, to perform feature detection and tracking based on the feature concatenation information to generate the tracking information includes to: perform feature decoding on adjusted voxel positions of the feature concatenation information to determine decoded feature data; identify features based on the decoded feature data; and track the identified features based on the decoded feature data over the two or more frames.

In a nineteenth aspect, in combination with one or more of the first aspect through the eighteenth aspect, processing system configured to cause the device to generate the feature concatenation information includes to: perform feature concatenation with spatio-temporal condition attention to generate the feature concatenation information based on camera feature data, LiDAR feature data, radar feature data, and the voxel position adjustment data.

In a twentieth aspect, in combination with one or more of the first aspect through the nineteenth aspect, the processing system configured to cause the device to perform the feature concatenation with the spatio-temporal condition attention to generate the feature concatenation information includes to: combine features of the camera feature data, the LiDAR feature data, and the radar feature data, based on the voxel position adjustment data to generate fused features of the feature concatenation information.

In a twenty-first aspect, in combination with one or more of the first aspect through the twentieth aspect, the fused features of the feature concatenation information are generated based on spatial information from LiDAR feature data, semantic information from the camera feature data, and motion information from the scene flow parameter data.

In a twenty-second aspect, in combination with one or more of the first aspect through the twenty-first aspect, the features of the camera feature data, the LiDAR feature data, and the radar feature data are combined and refined over multiple frames to generate the fused features, the multiple frames including the two or more frames.

In a twenty-third aspect, in combination with one or more of the first aspect through the twenty-second aspect, the transmission is a traveler information message (TIM), a sensor sharing message, or a connected and automated vehicle (CAV) message, and wherein the transmission indicates at least one object of the one or more objects.

In a twenty-fourth aspect, in combination with one or more of the first aspect through the twenty-third aspect, the autonomous driving system includes a collision detection system, a collision detection avoidance system, or a self-driving system.

In a twenty-fifth aspect, in combination with one or more of the first aspect through the twenty-fourth aspect, a method comprises: receiving point cloud data for two or more frames from a radar device; generating scene flow parameter data based on the point cloud data; generating voxel position adjustment data based on the scene flow parameter data; generating feature concatenation information associated with two or more sensors based on the voxel position adjustment data and feature information associated with the two or more sensors; performing feature detection and tracking based on the feature concatenation information to generate tracking information for one or more objects; and outputting the tracking information.

In a twenty-sixth aspect, in combination with one or more of the first aspect through the twenty-fifth aspect, a non-transitory computer-readable medium stores instructions that, when executed by a processor, cause the processor to perform operations comprising: receiving point cloud data for two or more frames from a radar device; generating scene flow parameter data based on the point cloud data; generating voxel position adjustment data based on the scene flow parameter data; generating feature concatenation information associated with two or more sensors based on the voxel position adjustment data and feature information associated with the two or more sensors; performing feature detection and tracking based on the feature concatenation information to generate tracking information for one or more objects; and outputting the tracking information.

Components, the functional blocks, and the modules described herein with respect to FIGS. 1-4 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device comprising:
a processing system that includes processor circuitry and memory circuitry that stores code and is coupled with the processor circuitry, the processing system configured to cause the device to:
receive point cloud data for two or more frames from a radar device;
generate scene flow parameter data based on the point cloud data;
generate voxel position adjustment data based on the scene flow parameter data;
generate feature concatenation information associated with two or more sensors based on the voxel position adjustment data and feature information associated with the two or more sensors;
perform feature detection and tracking based on the feature concatenation information to generate tracking information for one or more objects; and
output the tracking information.

2. The device of claim 1, wherein the processing system configured to cause the device to output the tracking information includes to:
provide the tracking information to an autonomous driving system; or
transmit a transmission based on the tracking information.

3. The device of claim 1, wherein the tracking information accounts for motion of the device and for motion of the one or more objects, and wherein the voxel position adjustment data corresponds to object motion correction information for the one or more objects.

4. The device of claim 1, wherein the two or more sensors include a camera device and a LiDAR device.

5. The device of claim 1, wherein the two or more sensors include a camera device, a LiDAR device, and the radar device.

6. The device of claim 1, wherein the processing system is further configured to cause the device to:
receive camera data from a camera device;
perform encoding to on the camera data generate camera feature data;
receive LiDAR data from a LiDAR device;
perform encoding on the LiDAR data to generate LiDAR feature data; and
perform encoding on the point cloud data from the radar device to generate radar feature data, and wherein the processing system configured to cause the device to generate the feature concatenation information includes to:
perform feature concatenation with spatio-temporal condition attention to generate the feature concatenation information based on the camera feature data, the LiDAR feature data, the radar feature data, and the voxel position adjustment data.

7. The device of claim 6, wherein the processing system configured to cause the device to perform the feature concatenation with the spatio-temporal condition attention to generate the feature concatenation information includes to:
adjust a voxel position of voxels in one or more of the camera feature data, the LiDAR feature data, and the radar feature data based on the voxel position adjustment data to account for motion of objects in the scene flow, wherein the feature concatenation information is generated based on the adjusted voxel position of the voxels.

8. The device of claim 7, wherein the processing system configured to cause the device to perform the feature concatenation with the spatio-temporal condition attention to generate the feature concatenation information further includes to:
identify corresponding voxels for a particular object in two or more of the camera feature data, the LiDAR feature data, and the radar feature data based on the adjusted position of the voxels; and
associate the identified corresponding voxels for the particular object in two or more of the camera feature data, the LiDAR feature data, and the radar feature data to combine identified corresponding voxels from different timestamps into a single timestamp, wherein the feature concatenation information is generated based on the combined voxels.

9. The device of claim 1, wherein the processing system configured to cause the device to adjust the feature concatenation information based on the voxel position adjustment data includes to:
adjust a three dimensional position of one or more voxels of the feature concatenation information based on the voxel position adjustment data.

10. The device of claim 1, wherein the point cloud data corresponds to a radar point cloud with range doppler information and range azimuth information.

11. The device of claim 1, wherein each point in the point cloud data contains three-dimensional (3D) positional information and 3D feature information, wherein 3D feature information includes radial relative velocity (RRV) information, radar cross section (RCS) information, power measurement information, or a combination thereof.

12. The device of claim 1, wherein the processing system configured to cause the device to generate the voxel position adjustment data based on the scene flow parameter data includes to:
generate scene flow parameters based on the point cloud data using a Radar Oriented Flow Estimation (ROFE) module and a Static Flow Refinement (SFR) module; and
generate the voxel position adjustment data based on the scene flow parameters.

13. The device of claim 12, wherein the ROFE module includes a multi-scale encoder, a cost volume layer, and a flow decoder, and wherein the SFR module includes a static mask generator and a Kabsch refiner.

14. The device of claim 13, wherein the ROFE module is configured to estimate a course scene flow based on voxel information from the point cloud and generates initial radar scene flow estimate information, wherein the SFR module is configured to refine the course scene flow to generate a final scene flow based on radial relative velocity (RRV) information from the point cloud and generates rigid radar scene flow information, and wherein the scene flow parameter data is generated based on the initial radar scene flow estimate information and the rigid radar scene flow information.

15. The device of claim 14, wherein the ROFE module is configured to:
generate local and global features from the point cloud data;
generate correlated feature information based on the local and global features;
generate grouped feature information based on the local and global features and the correlated feature information; and
generate the initial radar scene flow estimate information based on the grouped feature information, wherein the scene flow parameter data is generated based on the initial radar scene flow estimate information.

16. The device of claim 13, wherein the SFR module is configured to:
generate, by the static mask generator, a static mask;
determine static points of point clouds for the two or more frames based on the static mask and the point cloud data; and
generate, by the Kabsch refiner, a transformation matrix based on the static points and on a differentiable Kabsch algorithm; and
derive the rigid radar scene flow information from the transformation matrix, wherein the scene flow parameter data is generated based on the rigid radar scene flow information.

17. The device of claim 1, wherein the processing system configured to cause the device to adjust the feature concatenation information based on the voxel position adjustment data includes to:
adjust a three dimensional position of one or more voxels of the feature concatenation information based on the voxel position adjustment data.

18. The device of claim 1, wherein the processing system configured to cause the device to perform feature detection and tracking based on the feature concatenation information to generate the tracking information includes to:
perform feature decoding on adjusted voxel positions of the feature concatenation information to determine decoded feature data;
identify features based on the decoded feature data; and
track the identified features based on the decoded feature data over the two or more frames.

19. The device of claim 1, wherein the processing system configured to cause the device to generate the feature concatenation information includes to:
perform feature concatenation with spatio-temporal condition attention to generate the feature concatenation information based on camera feature data, LiDAR feature data, radar feature data, and the voxel position adjustment data.

20. The device of claim 19, wherein the processing system configured to cause the device to perform the feature concatenation with the spatio-temporal condition attention to generate the feature concatenation information includes to:
combine features of the camera feature data, the LiDAR feature data, and the radar feature data, based on the voxel position adjustment data to generate fused features of the feature concatenation information.

21. The device of claim 20, wherein the fused features of the feature concatenation information are generated based on spatial information from LiDAR feature data, semantic information from the camera feature data, and motion information from the scene flow parameter data.

22. The device of claim 20, wherein the features of the camera feature data, the LiDAR feature data, and the radar feature data are combined and refined over multiple frames to generate the fused features, the multiple frames including the two or more frames.

23. A method comprising:
receiving point cloud data for two or more frames from a radar device;
generating scene flow parameter data based on the point cloud data;
generating voxel position adjustment data based on the scene flow parameter data;
generating feature concatenation information associated with two or more sensors based on the voxel position adjustment data and feature information associated with the two or more sensors;
performing feature detection and tracking based on the feature concatenation information to generate tracking information for one or more objects; and
outputting the tracking information.

24. A non-transitory computer-readable medium stores instructions that, when executed by a processor, cause the processor to perform operations comprising:
receiving point cloud data for two or more frames from a radar device;
generating scene flow parameter data based on the point cloud data;
generating voxel position adjustment data based on the scene flow parameter data;
generating feature concatenation information associated with two or more sensors based on the voxel position adjustment data and feature information associated with the two or more sensors;
performing feature detection and tracking based on the feature concatenation information to generate tracking information for one or more objects; and
outputting the tracking information.
